(19) United States
(12) Patent Application Publication
(10) Pub. No.: US 2015/0095267 A1
(43) Pub. Date: Apr. 2, 2015

(54) TECHNIQUES TO DYNAMICALLY GENERATE REAL TIME FREQUENTLY ASKED QUESTIONS FROM FORUM DATA

(71) Applicant: Avaya Inc., Basking Ridge, NJ (US)

(72) Inventors: Shweta Behere, San Jose, CA (US); Rahul Buddhisagar, San Jose, CA (US)

(73) Assignee: Avaya Inc., Basking Ridge, NJ (US)

(21) Appl. No.: 14/041,570

(22) Filed: Sep. 30, 2013

(51) Int. Cl. G06N 5/04; H04L 29/06

(52) U.S. Cl. CPC G06N 5/04; H04L 67/42
USPC 706/11

(57) ABSTRACT

Techniques to dynamically generate real time frequently asked questions from forum data are described. In one embodiment, for example, an apparatus may comprise a preprocessor, a validator, a data module, and a list regenerator. The preprocessor may be operative to receive a user entry to a forum and to generate a processed entry. The validator may be operative to receive the processed entry, to receive an accuracy rating for the processed entry from a data module, and to forward the processed entry for inclusion in an existing frequently-asked-questions (FAQ) list based on the accuracy rating and rules. The data module may be operative to receive the processed entry and to determine the accuracy rating of the processed entry. The list regenerator may be operative to receive the processed entry and to regenerate the existing FAQ list into an updated FAQ list including the processed entry. Other embodiments are described and claimed.

### BACKGROUND

Users who interact with a device, piece of software, service, or other product may develop questions on how to use the product. Some product developers provide lists of frequently asked questions (FAQ) for their products, which pair common questions with their answers, to help users. These FAQs may serve to provide assistance in a more cost-effective manner than providing in-person, telephonic, or text-based support by a human being. Further, a FAQ may be published on the Internet, such as on a web page, where it may be viewed continuously and at any time, as compared to the potentially limited hours that a human support staff may be available. Some users may also benefit from reading a FAQ before using a product in order to learn of potential mistakes, to learn about potentially-confusing features, or to otherwise prevent a question on the FAQ from ever being raised or being an issue. FAQs may also be used to provide information other than for support. A FAQ may contain questions commonly asked before purchasing a product, reselling the product, trading in a product, requesting a product be replaced, requesting a product be repaired, or any other type of transaction between a user and a producer related to the product. It will be appreciated that a FAQ may also be offered by a third-party seller, by a user community, or by any other individual or organization with an interest in a product. Similarly, it will be appreciated a FAQ may relate to services, objects, or other topics not generally considered to be products, such as a FAQ for a state park, topic of discussion (e.g., gardening), etc.

However, some embodiments of an FAQ may depend on a human expert to explicitly provide question-and-answer pairs for the FAQ and may depend on a human administrator or maintainer to update the FAQ, such as by editing a web page or database. This may lead to a FAQ growing out of date due to limited resources by the human expert, administrator, or more generally a business entity responsible for the FAQ. This may be particularly true for older products, which often receive less attention than new products. For example, customers may have questions related to getting an older piece of software, no longer receiving updates from its provider, to run on newer computer systems. These types of older products, which no longer receive updates, may be the ones most likely to have FAQs that have also languished and not been updated. As such, some customer questions—such as how to use older software on newer systems—may be precisely those which despite being common are not added to a FAQ as it grows stale.

Customers may therefore turn to user forums to receive assistance on topics not covered by the FAQ. A customer with a question not covered by a FAQ may post a thread on a user forum containing their question and hope to receive answers. In some cases, the user may receive no answers, multiple answers, or no helpful answers. However, in some cases, helpful answers may be provided. Experts working for the provider for a product may monitor user forums and post answers, either as an explicit part of their job or on their own initiative. Third-party experts, without a formal relationship with the provider—or without a formal relationship other than as a customer of the provider—may have sufficient experience with the product to provide useful advice and may contribute to the forum on their own initiative. Similarly, some providers may provide benefits to third-party experts who helpfully contribute to user forums, such as special titles, special privileges, product discounts, or other promotions to honor the third-party expert's contributions. As such, user forums may provide a resource for customers to receive information regarding topics not covered by the FAQ.

As user forums may retain the availability of threads after a question is answered, old threads—threads in which a user question has been satisfactorily answered—may allow a user forum to be a resource for customers even without them posting a question. A customer may search a user forum for questions similar to theirs and examine some or all threads with such similar questions. In some cases this may involve using a search feature specific to that forum and provided as part of the forum, and in some cases this may involve the user searching for that question in a general Internet search engine (e.g., Google™, Bing™) and following links to specific threads that appear in results there. However, these searches may not prioritize the threads with the best answers in them, may not identify the best answer, and may generally require significantly more user effort to cull and utilize than if the best answer were included with the question in the FAQ.

Thus, there is a need for improvements in techniques for generating frequently asked questions from forum data.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to dynamically generate frequently asked questions from forum data. Some embodiments are particularly directed to techniques for real-time rule based monitoring of forum data to dynamically generate frequently asked questions. In one embodiment, for example, an apparatus may comprise a preprocessor, a validator, a data module, and a list regenerator. The preprocessor may be operative to receive a user entry to a forum and to generate a processed entry. The validator may be operative to receive the processed entry, to receive an accuracy rating for the processed entry from a data module, and to forward the processed entry for inclusion in an existing frequently-asked-questions (FAQ) list based on the accuracy rating and rules. The data module may be operative to receive the processed entry and to determine the accuracy rating of the processed entry. The list regenerator may be operative to receive the processed entry and to regenerate the existing FAQ list into an updated FAQ list including the processed entry. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a FAQ regeneration system to dynamically generate frequently asked questions from forum data.

FIG. 2 illustrates an embodiment of a logic flow for the system of FIG. 1.

FIG. 3 illustrates an embodiment of a centralized system for the system of FIG. 1.

FIG. 4 illustrates an embodiment of a distributed system for the system of FIG. 1.

FIG. 5 illustrates an embodiment of a computing architecture.

FIG. 6 illustrates an embodiment of a communications architecture.

### DETAILED DESCRIPTION

Various embodiments are directed to techniques to dynamically generate frequently asked questions from forum data. Customers for a business or users of a service provided by an organization may benefit from a FAQ list that is automatically and programmatically updated with question-and-answer pairs from a user forum. A FAQ regeneration system may cull the most accurate answers from a user forum and place them, with their associated question, in a FAQ list for use by customers. Customers may therefore receive the convenience of having each question being asked only once and answered with only the best question, while still receiving the breadth of support and continued updates, which may be available in a user forum. The FAQ provider may receive a reduced cost to providing the FAQ list, reduced use (and therefore cost) of a call center by users whose questions wouldn't be answered by a static FAQ list, and greater customer satisfaction (and therefore retention) through a higher-quality FAQ list. As a result, the embodiments can improve the affordability, scalability, and utility of a FAQ list for both the user and the provider.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

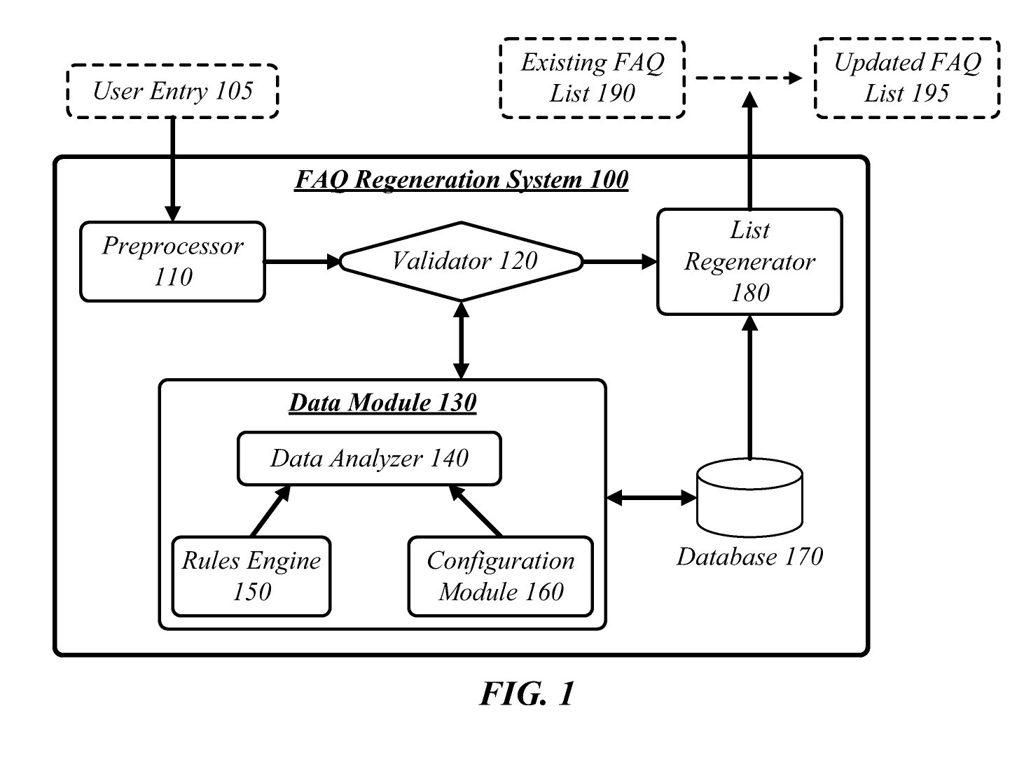

FIG. 1 illustrates a block diagram for a FAQ regeneration system 100. In one embodiment, the FAQ regeneration system 100 may comprise a computer-implemented FAQ regeneration system 100 comprising one or more components. Although the FAQ regeneration system 100 shown in FIG. 1 has a limited number of elements in a certain topology, it may be appreciated that the FAQ regeneration system 100 may include more or less elements in alternate topologies as desired for a given implementation. In one embodiment, the FAQ regeneration system 100 may comprise a preprocessor 110, validator 120, data module 130, database 170, and list regenerator 180. The data module 130 may itself comprise a plurality of components: a data analyzer 140, rules engine 150, and configuration module 160.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The FAQ regeneration system 100 may be generally arranged to receive user entries, to determine the accuracy of the user entries, and to update a FAQ list using those user entries, which are determined to be sufficiently accurate and which cover questions not yet included in the FAQ list or which cover those questions at a higher accuracy than the FAQ list currently does. The FAQ regeneration system 100 may operate according to a set of rules defined in a rules engine 150, which operate in conjunction with knowledge related to the subject of the FAQ stored in a database 170 to manage the FAQ. The FAQ regeneration system 100 may operate on received user entries such as user entry 105 and may operate on those user entries to update an existing FAQ list 190 to an updated FAQ list 195.

The user entry 105 may generally relate to a user submission of information to a user forum. A user forum may comprise any discussion forum used by users for discussion. A user forum may be provided by a company that creates a product or provides a service, such as a product-specific forum or a company-specific forum covering multiple products or services by the same company. For example, a business may operate a web forum for discussion of their products, with section or categories for specific types of products or individual products. Alternatively, a forum may be provided by a third party, and may be specific to a particular product, to a particular company, to a particular category of products across multiple companies, or may be for any other topic. A user forum may be an Internet-based or web-based user forum. A user forum may be publicly accessible, may allow anonymous viewing and/or posting, may require registration for viewing and/or posting, and may only be accessible by registered customers of a company and/or registered owners of a product or service.

A user forum may contain a plurality of threads, wherein a thread comprises a linear or hierarchical discussion spawned from an initiating post. For example, an initiating user may post a question as a new thread. Other users may visit the new thread, read the question, and post responses to the question and responses to the responses of others. In some embodiments, a linear ordering may be used for display of the thread, where all discussions within that thread are displayed in sequence. In some embodiments, a hierarchical ordering may be used for display of the thread, where each response is specifically a response to either the initiating question or another response and these responses are visually displayed in a branching tree-like hierarchy. Any technique for managing and displaying the contents of a thread on a web forum may be used. In general, a thread may comprise an initiating post, such as a question, and zero or more additional posts comprising the discussion initiated by the initiating post.

The user entry 105 may comprise some or all of a thread. In some embodiments, the user entry 105 may comprise the entirety of a thread: an initiating post and a plurality of responses, such that the entire thread will be evaluated by the FAQ regeneration system 100. In some embodiments, the user entry 105 may comprise a single response within the thread, such that the FAQ regeneration system 100 will evaluate each response individually. Where the user entry 105 comprises only one response of a plurality of responses in a thread, the user entry 105 may also comprise the initiating question for context in analyzing the response and for potential inclusion as the question of a question-and-answer pair if the user entry 105 is selected by the FAQ regeneration system 100 for inclusion in a FAQ.

The FAQ regeneration system 100 may comprise a preprocessor 110. The preprocessor 110 may be operative to receive a user entry 105 to a forum and to generate a processed entry. The preprocessor 110 may generate the processed entry in response to the user entry 105 being submitted to the forum in real time. The user entry 105 being processed in real time may refer to the processing being responsive to a user submitting the user entry 105, the user entry 105 being received by the forum, or the process otherwise being initiated in response to an external action rather than an internal schedule of the FAQ regeneration system 100. Delay may still be introduced between the submission of the user entry 105, such as communication delay, processing delay, delay generated from a queue of user entries, or other forms of delay related to the finite computing or network capabilities. Where the user entry 105 comprises an initiating question and a plurality of user answers, the preprocessor 110 may initiate the generation of the processed entry in response to the user forum receiving the most recent of the plurality of user answers. Where the user entry 105 comprises a user question and a single user answer, the preprocessor 110 may initiate the generation of the processed entry in response to the user forum receiving that user answer.

The FAQ regeneration system 100 may comprise a validator 120 operative to receive the processed entry, to receive an accuracy rating for the processed entry from a data module 130, and to forward the processed entry for inclusion in an existing frequently-asked-questions (FAQ) list 190 based on the accuracy rating. The accuracy rating may generally represent an estimated accuracy of the user entry 105, some portion of the user entry 105, or a plurality of accuracy ratings each corresponding to a plurality of user answers which comprise the user entry 105.

The FAQ regeneration system 100 may comprise a data module 130 operative to receive the processed entry and to determine the accuracy rating of the processed entry. The data module 130 may receive the processed entry via the validator 120 or directly from the preprocessor 110 that generated it. The data module 130 may transmit the determined accuracy rating of the processed entry to the validator 120 for use in its determination of whether or not to forward the processed entry for inclusion in the FAQ. The data module 130 may be operative to determine the accuracy rating using a database 170 storing knowledge related to the subject matter of the FAQ list, such as product-specific information. The data module 130 may itself comprise a data analyzer 140, rules engine 150, and configuration module 160.

The configuration module 160 may be used in the initial configuration of the data module 130 specifically and the FAQ regeneration system 100 in general. For example, the configuration module 160 may confirm proper licensing for the FAQ regeneration system 100, assist in software installation, be used in establishing a relationship with a user forum, and otherwise perform the initial deployment of the FAQ regeneration system 100. As another example, the configuration module may feed initial data to the FAQ regeneration system such as some pre-existing question-answer pairs and keywords associated with them.

The rules engine 150 may store, maintain, and apply rules, such as administrator-defined rules, for determining the accuracy rating of the processed entry. Those rules may comprise, without limitation, a determined number of times a substantially similar question has been asked, a predefined window of time within which the substantially similar questions were asked, a list of recognized users with high accuracy ratings, and a threshold for a user helpfulness rating of a user answer, the user entry comprising the user answer. Rules may also have a predefined set of keywords. The administrator can then create rules to include or not include question-answer pairs with those keywords in the updated FAQ list. The administrator can create a rule to force certain question-answer pairs with those keywords to be included in the regenerated FAQ list. For example, this is needed when a new product or service is launched and the product or service developer knows that the customer is very likely going to ask questions related to a particular feature or keyword.

On the other hand, the administrator can create a rule to force question-answer pairs with certain keywords to not be included in the regenerated FAQ list. Such type of rule can be used for keywords related to older products or services and outdated features or types of services.

The data analyzer 140 may act as the bridge and point of contact between the rules engine 150 and the database 170. For instance, the rules engine 150 may use a plurality of rules. Each or some portion of the rules may contribute to determining the accuracy rating of a processed entry. Rules-based contributions to an accuracy rating of a processed entry may be additive, multiplicative, or any other mathematical or programmatic technique of combining multiple ratings, with the technique for combining rating being a global policy for the data module 130 or a rules-specific policy defined for each rule.

In some embodiments, users may be able to rate the helpfulness of a particular user answer; in some cases only the user asking the initiating question may rate answers, and in other cases any user may rate answers. A rule may therefore indicate a transformation from a user helpfulness rating of a user answer to a contribution to the accuracy rating of a user entry 105. In some cases, a user entry 105 may be processed by the preprocessor 110 in real time in response to a user helpfulness rating being received for a user answer by the user forum, with the user entry 107 comprising the rated user answer and its helpfulness rating.

In some embodiments, users of a forum may have an accuracy rating associated with them. Some users of a user forum may be recognized as possessing subject matter expertise and therefore have a high accuracy rating. The accuracy rating for a user may be determined according to an explicit setting by a human—such as a administrator for the user forum or the FAQ regeneration system 100—or may be implicitly determined based on the user's behavior on the forum, such as an accumulated total, average, or weighted average of user helpfulness ratings for answers submitted by the user. A rule may therefore indicate a transformation from a user-specific accuracy rating to an accuracy rating of a processed entry based on an answer by the user. In general, the accuracy rating for a user entry 105 may be increased based on the user answer having been submitted by a recognized user with a predetermined high accuracy rating. The user having a predetermined high accuracy rating may correspond to the accuracy rating for the user being determined prior to the specific user answer included in the user entry 105 having been received, with the accuracy rating for the user therefore being independent of the user entry 105 being evaluated.

The FAQ regeneration system 100 may comprise a list regenerator 180 operative to receive the processed entry from the validator 120 and to regenerate the existing FAQ list 190 into the updated FAQ list 195 including the processed entry. The updated FAQ list 190 including the processed entry does not necessarily mean that every element of the processed entry is included in the updated FAQ list 190 and may instead comprise the list regenerator 180 extracting those elements useful in the creation of a question-and-answer pair. For instance, where the processed entry comprises a user question a plurality of user answers with one best answer identified by the validator 120, the list regenerator 180 may extract the user question and the best answer and form them into a question-and-answer pair for inclusion in the updated FAQ list 195.

In some embodiments, the FAQ list may be published on a web page. The list regenerator 180 may be operative to publish the updated FAQ list 195 as an updated web page, replacing the existing FAQ list 190 on the web page. For instance, the FAQ may be published as an HTML document with the list regenerator 180 rewriting the HTML document to incorporate changes to the FAQ. In some embodiments, the FAQ may be stored in a database, such as database 170. The list regenerator 180 may be operative to update the database to comprise the new entries of the updated FAQ list 195. The web page for displaying the updated FAQ list 195 may therefore be generated from the database 170. In some embodiments, the web page may be generated from the database 170 to produce a static HTML web page comprising the updated FAQ list 195. In alternate embodiments, the web page may be generated from the database 170 when the page is loaded, such as may be used with a dynamic HTML web page. Any known technique for generating and regenerating web pages may be used.

In some embodiments, the user entry 105 may comprise a user question that initiated a question thread on a forum and a plurality of user answers posted to the question thread. The data module 130 may be operative to determine the accuracy rating as a plurality of answer-specific accuracy ratings, each of the plurality of answer-specific accuracy ratings corresponding to one of the plurality of user answers. The validator 120 may be operative to select a best user answer from the plurality of user answers based on the plurality of answer-specific accuracy ratings and to indicate the selected best user answer in the forwarded processed entry. The list regenerator 180 may be operative to use the user question and the selected best user answer as a new question-and-answer pair in the updated FAQ list 195. The user entry 105 comprising the user question and plurality of user answers may be analyzed in real time in response to the most recent of the plurality of user answers being posted or may be analyzed on a set schedule, such as hourly, daily, etc.

In some cases, a question-and-answer pair on the existing FAQ list 190 may be replaced by a new question-and-answer pair where the answer from the new question-and-answer pair has a higher accuracy rating. As such, in some embodiments, the user entry 105 may comprise a user question that initiated a question thread on a forum and a single new user answer posted to the question thread, the existing FAQ list comprising a similar question to the user question. The data module 130 may be operative to determine the accuracy rating based on the new user answer. The validator 120 may be operative to forward the processed entry for inclusion based on the determined accuracy rating being higher than an existing accuracy rating for an associated answer to the similar question. The list regenerator 180 may be operative to remove the associated answer as part of regenerating the existing FAQ list into the updated FAQ list. In some cases the list regenerator 180 may also remove the similar question from the existing FAQ list 190 in generating the updated FAQ list 195, the similar question replaced by the user question that initiated the question thread. In some cases the list regenerator 180 may retain the existing similar question and merely replace the associated answer with the new user answer. In particular, the existing similar question may be retained when the existing similar question is the same question from the same question thread with the new user answer a newer, superior answer to the existing associated answer. As such, the FAQ may be continuously updated to always have the best available answer for each of its questions.

In some embodiments, the user entry 105 may be tokenized into keywords. The preprocessor 110 may be operative to receive the user entry 105 and to produce a set of keywords based on the user entry 105, the processed entry comprising the keywords. Where the user entry 105 comprises a user question and a single user answer, the keywords may comprise a question set produced from the user question and an answer set produced from the user answer. Where the user entry 105 comprises a user question and a plurality of user answers, the keywords may comprise a question set and a plurality of answer sets corresponding to each of the plurality of user answers. The keywords may be generated based on the knowledge stored in the database 170, which may include a listing of known keywords relevant to the subject matter of the FAQ. The tokenization may only produce keywords which explicitly appear in the user entry 105 or may produce keywords which do not explicitly appear in the user entry 105, such as where the preprocessor 110 uses a mapping from words to keywords wherein multiple words may be mapped to the same keyword. In general, any known technique for tokenization may be used.

In some embodiments, the processed entry may comprise a first set of keywords generated by the preprocessor 110 based on the user entry. The existing FAQ list 190 may comprise a related question with an associated second set of keywords. The data module 130 may be operative to determine the accuracy rating for the user entry 105 based on a comparison of the first set of keywords and the second set of keywords. In other embodiments, weights can be assigned to keywords and thus while comparing the first set of keywords to the second one, the highest weighted average/sum would be selected. This is just one of many approaches, another one being how many keywords are hit.

The FAQ regeneration system 100 may attempt to limit the extent to which duplicate questions proliferate in the FAQ and may attempt to avoid substantially similar questions from being included in the FAQ. As such, where the processed entry comprises one or more keywords generated by the preprocessor 110 based on the user entry 105, the validator 120 may be operative to forward the processed entry for inclusion in the updated FAQ list 195 based on the keywords indicating that a user question is not substantially similar to one already included in the existing FAQ list 190. The determination of whether the user question is substantially similar to one already in the existing FAQ list 190 may be based on a comparison between the one or more keywords from the processed entry and one or more keywords associated with the one already included in the existing FAQ list 190. Two questions may be substantially similar if the keywords for both questions are exactly the same or have a sufficient degree of overlap. Two sets of keywords may have a sufficient degree of overlap if a threshold number of keywords are shared by both sets of keywords or if a threshold percentage of keywords are shared by both sets of keywords.

In some embodiments, only questions in which there is evidence of user interest will be added to the FAQ. A FAQ which includes every question any user has ever asked may grow to a size that is impractical for users to search and absorb information from. As such, the data module 130 may be operative to determine a number of times a substantially similar question to the user question from the user entry 105 has been asked, the validator 120 operative to forward the processed entry for inclusion in the FAQ list 195 based on the determined number of times exceeding a threshold. In some embodiments the data module 130 may be operative to determine the number of times the substantially similar question has been asked within a predefined window of time. In some cases, only similar questions from within the predefined window of time may be considered, such that the threshold is effectively on the rate at which similar questions have been asked. Alternatively, both an overall count of the number of times a similar question has been asked may be determined as well as a specific count within the predefined window of time. In these cases a first threshold may be used for the overall count and a second threshold may be used for the specific count from within the window. The second threshold may be set lower than the first, so a question may be included in the FAQ based on a high overall interest or based on sufficient interest within the window of time to allow through a question which is rising in interest. For example, a question that meets a threshold based on the overall count may be one which only occurs for a subset of users and therefore takes time to rise in prominence. A question that meets a threshold based on the specific count from within a window of time may be one which has only recently become relevant, such as where a question relates to a new version of a piece of software.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

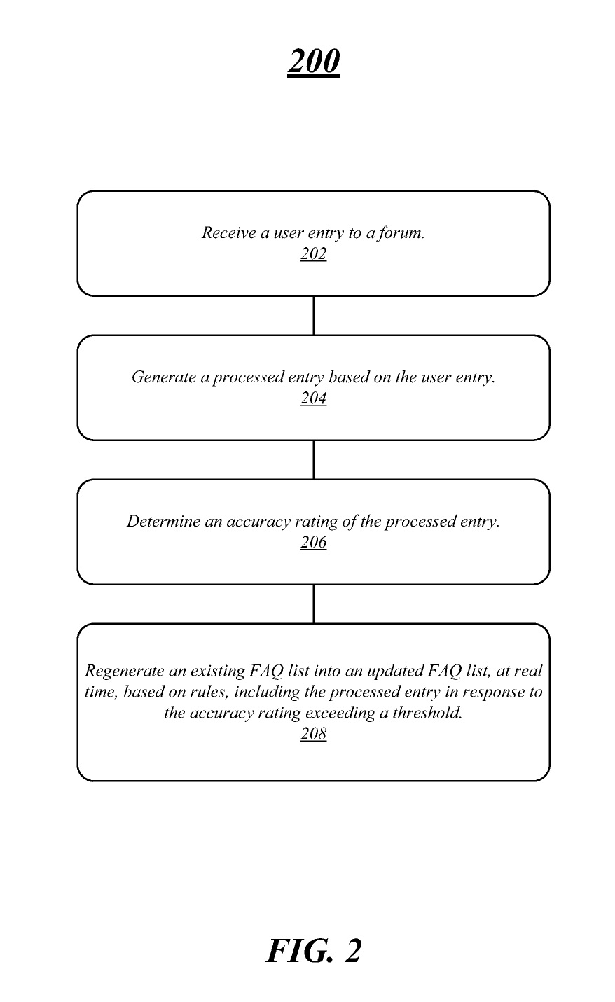

FIG. 2 illustrates one embodiment of a logic flow 200. The logic flow 200 may be representative of some or all of the operations executed by one or more embodiments described herein.

In the illustrated embodiment shown in FIG. 2, the logic flow 200 may receive a user entry 105 to a forum at block 202. For example, the user entry 105 may comprise a user question and one or more user answers. The user question may have initiated a thread on the forum. The one or more users answers may be responses to the user question posted in that same thread on the forum.

The logic flow 200 may generate a processed entry based on the user entry 105 at block 204. For example, the processed entry may comprise one or more keywords, with some of the keywords corresponding to a user question and some of the keywords corresponding to the one or more user answers.

The logic flow 200 may determine an accuracy rating of the processed entry at block 206. For example, they accuracy rating may be determined based on the one or more keywords. The keywords for a user question may be compared with keywords associated with questions already in the FAQ to determine whether the question, or a substantially similar question, has already been asked. If a substantially similar question has already been asked then the processed entry may be examined to determine whether an answer comprising part of the user entry 105 is superior—of a higher accuracy—than the existing answer to the substantially similar question.

The logic flow 200 may regenerate an existing FAQ list 190 into an updated FAQ list 195 including the processed entry in response to the accuracy rating exceeding a threshold at block 208. After the updated FAQ list is generated it may be published to a web page either directly or indirectly through the updating of a database 170.

The embodiments are not limited to this example.

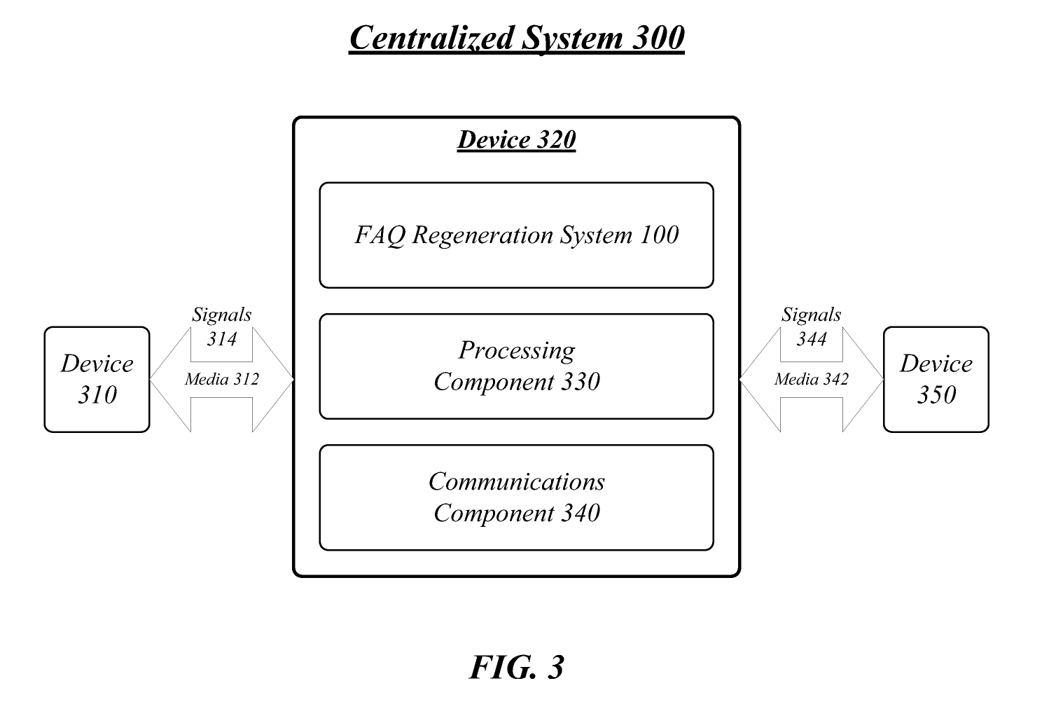

FIG. 3 illustrates a block diagram of a centralized system 300. The centralized system 300 may implement some or all of the structure and/or operations for the FAQ regeneration system 100 in a single computing entity, such as entirely within a single device 320.

The device 320 may comprise any electronic device capable of receiving, processing, and sending information for the FAQ regeneration system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 320 may execute processing operations or logic for the FAQ regeneration system 100 using a processing component 330. The processing component 330 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 320 may execute communications operations or logic for the FAQ regeneration system 100 using communications component 340. The communications component 340 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 340 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 312, 342 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 320 may communicate with other devices 310, 350 over a communications media 312, 342, respectively, using communications signals 314, 344, respectively, via the communications component 340. The devices 310, 350 may be internal or external to the device 320 as desired for a given implementation.

Device 310 may comprise a server hosting a user forum related to or including discussion related to the subject of the FAQ. Signals 314 sent over media 312 may therefore comprising the transmission of a user entry 105 from the user forum to the FAQ regeneration system 100. The device 350 may comprise a web server hosting the FAQ. The signals 344 sent over media 342 may therefore comprise the transmission of the updated FAQ list 195 from the FAQ regeneration system 100 to the web server.

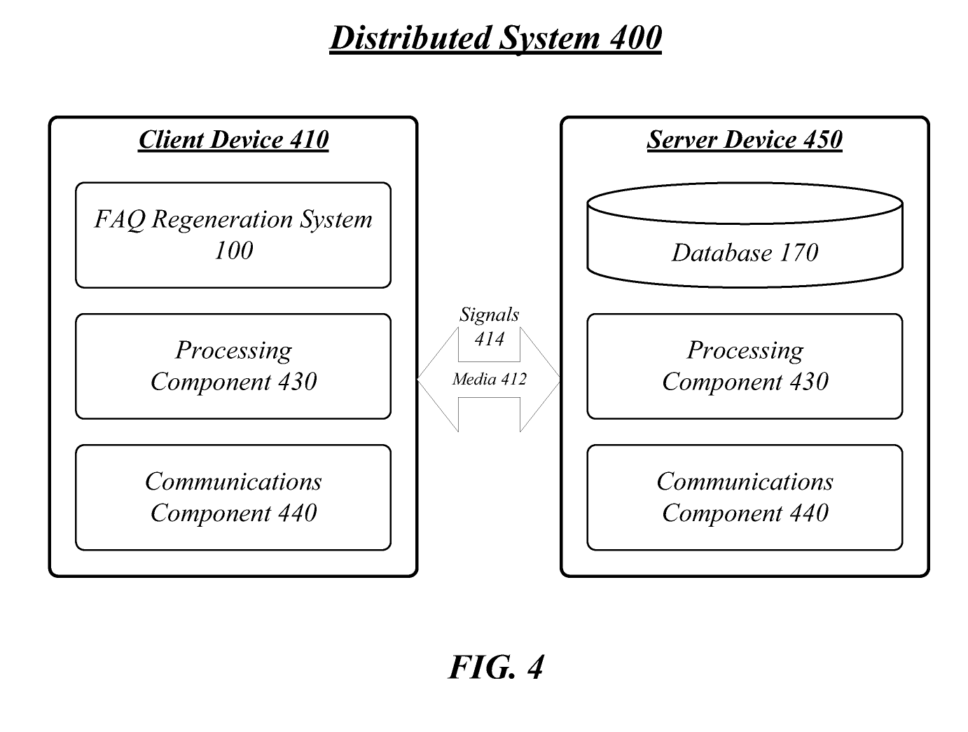

FIG. 4 illustrates a block diagram of a distributed system 400. The distributed system 400 may distribute portions of the structure and/or operations for the FAQ regeneration system 100 across multiple computing entities. Examples of distributed system 400 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 400 may comprise a client device 410 and a server device 450. In general, the client device 410 and the server device 450 may be the same or similar to the client device 320 as described with reference to FIG. 3. For instance, the client system 410 and the server system 450 may each comprise a processing component 430 and a communications component 440 which are the same or similar to the processing component 330 and the communications component 340, respectively, as described with reference to FIG. 3. In another example, the devices 410, 450 may communicate over a communications media 412 using communications signals 414 via the communications components 440. The client device 410 may comprise or employ one or more client programs that operate to perform various methodologies in accordance with the described embodiments. In one embodiment, for example, the client device 410 may implement the processing components of the FAQ regeneration system, such as preprocessor 110, validator 120, data module 130, and list regenerator 180. The server device 450 may comprise or employ one or more server programs that operate to perform various methodologies in accordance with the described embodiments.

In one embodiment, for example, the server device 450 may implement the database 170. Server device 450 may comprise a distributed server device 450 hosting a database 170 for use by the FAQ regeneration system 100. The signals 414 sent over media 412 may comprise communication between the data module 130 and the database 170 and between the list regenerator 180 and the database 170. The database 170 may also operate in conjunction with a web server, such as described with reference to FIG. 3. For instance, a web server dynamically generating an FAQ web page based on the existing FAQ list 195 may access the existing FAQ list 195 from the database 170.

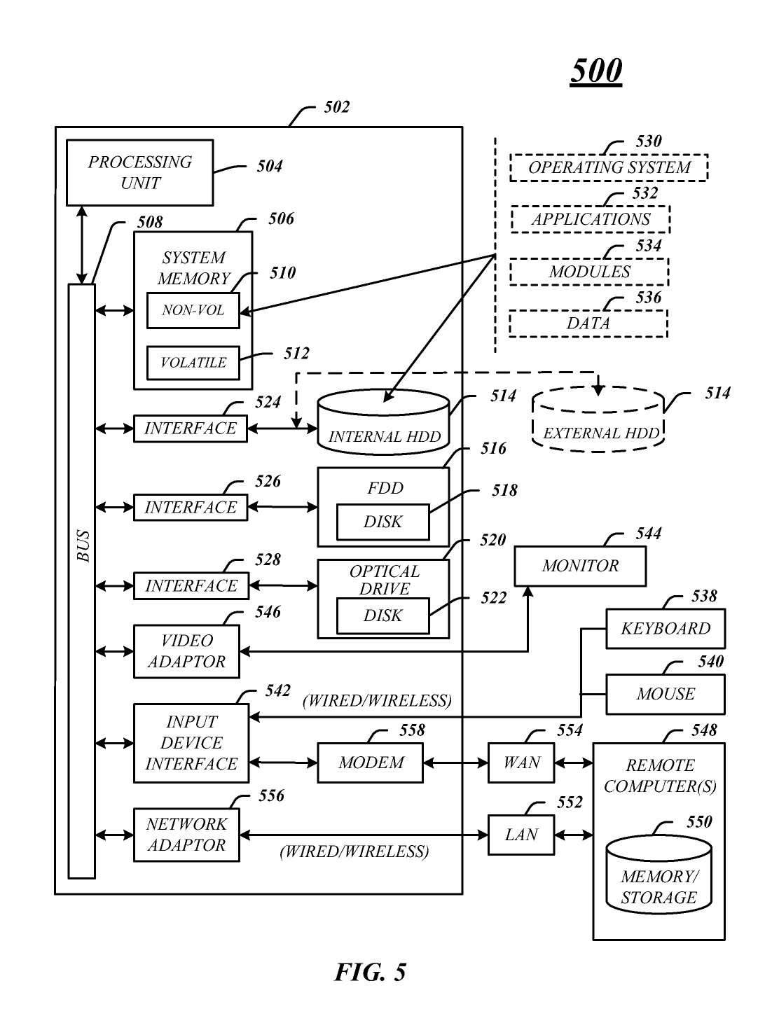

FIG. 5 illustrates an embodiment of an exemplary computing architecture 500 suitable for implementing various embodiments as previously described. In one embodiment, the computing architecture 500 may comprise or be implemented as part of an electronic device. Examples of an electronic device may include those described with reference to FIG. 3 and FIG. 5, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 comprises a processing unit 504, a system memory 506 and a system bus 508. The processing unit 504 can be any of various commercially available processors, including without limitation an AMD® Athlon®, Duron® and Opteron® processors; ARMO application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 504.

The system bus 508 provides an interface for system components including, but not limited to, the system memory 506 to the processing unit 504. The system bus 508 can be any of several types of bus structure that may further interconnect to a memory bus (with or without a memory controller), a peripheral bus, and a local bus using any of a variety of commercially available bus architectures. Interface adapters may connect to the system bus 508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 500 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 5, the system memory 506 can include non-volatile memory 510 and/or volatile memory 512. A basic input/output system (BIOS) can be stored in the non-volatile memory 510.

The computer 502 may include various types of computer-readable storage media in the form of one or more lower speed memory units, including an internal (or external) hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536. In one embodiment, the one or more application programs 532, other program modules 534, and program data 536 can include, for example, the various applications and/or components of the FAQ regeneration system 100.

A user can enter commands and information into the computer 502 through one or more wire/wireless input devices, for example, a keyboard 538 and a pointing device, such as a mouse 540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. The monitor 544 may be internal or external to the computer 502. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.5 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.5x (a, b, g, n, etc.) to provide secure, reliable, fast wireless connectivity. A Wi-Fi network can be used to connect computers to each other, to the Internet, and to wire networks (which use IEEE 802.3-related media and functions).

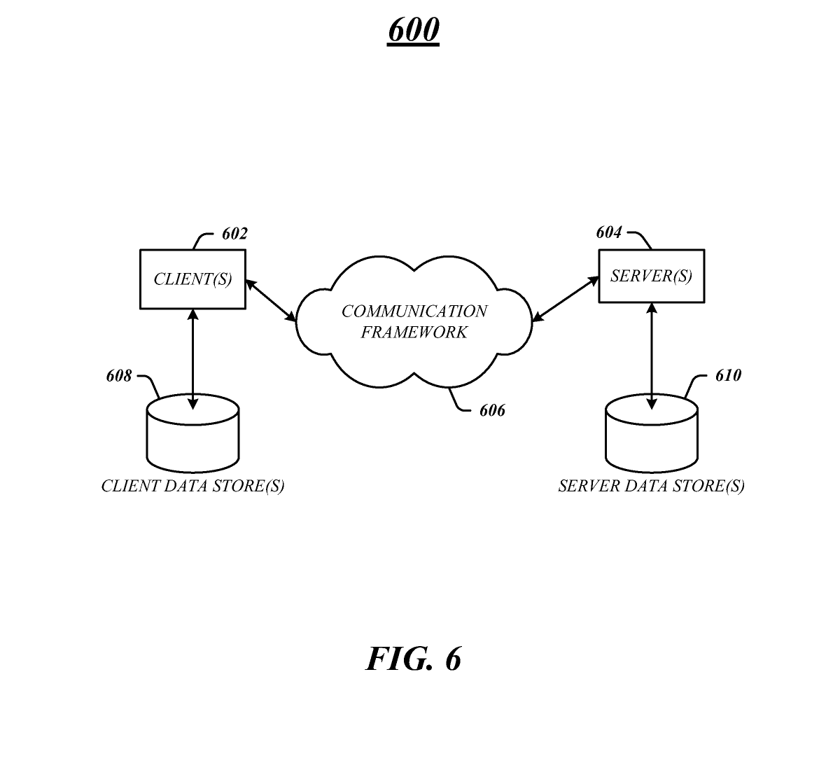

FIG. 6 illustrates a block diagram of an exemplary communications architecture 600 suitable for implementing various embodiments as previously described. The communications architecture 600 includes various common communications elements, such as a transmitter, receiver, transceiver, radio, network interface, baseband processor, antenna, amplifiers, filters, power supplies, and so forth. The embodiments, however, are not limited to implementation by the communications architecture 600.

As shown in FIG. 6, the communications architecture 600 comprises includes one or more clients 602 and servers 604. The clients 602 may implement the client device 410. The servers 604 may implement the server device 450. The clients 602 and the servers 604 are operatively connected to one or more respective client data stores 608 and server data stores 610 that can be employed to store information local to the respective clients 602 and servers 604, such as cookies and/or associated contextual information.

The clients 602 and the servers 604 may communicate information between each other using a communication framework 606. The communications framework 606 may implement any well-known communications techniques and protocols. The communications framework 606 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 606 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 602 and the servers 604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a processor circuit on a device;
a preprocessor operative on the processor circuit to receive a user entry to a forum and to generate a processed entry;
a validator operative on the processor circuit to receive the processed entry, to receive an accuracy rating for the processed entry from a data module, and to forward the processed entry for inclusion in an existing frequently-asked-questions (FAQ) list based on the accuracy rating and rules;
the data module operative to receive the processed entry and to determine the accuracy rating of the processed entry; and
a list regenerator operative to receive the processed entry and to regenerate the existing FAQ list, at real-time or dynamically, into an updated FAQ list including the processed entry.

2. The apparatus of claim 1, the preprocessor operative to generate the processed entry in response to the user entry being submitted to the forum in real time.

3. The apparatus of claim 1, the user entry comprising a user question and a user answer, the processed entry comprising a first set of keywords generated by the preprocessor based on the user entry, the existing FAQ list storing a related question with an associated second set of keywords, the data module operative to determine the accuracy rating based on a comparison of the first set of keywords and the second set of keywords.

4. The apparatus of claim 1, the user entry comprising a user question and a user answer, the accuracy rating increased based on the user answer having been submitted by a recognized user with a predetermined high accuracy rating.

5. The apparatus of claim 1, the user entry comprising a user question and a user answer, the data module operative to determine a number of times a substantially similar question to the user question has been asked, the validator operative to forward the processed entry for inclusion in the updated FAQ list based on the determined number of times exceeding a threshold.

6. The apparatus of claim 1, the user entry comprising a user question and a user answer, the processed entry comprising one or more keywords generated by the preprocessor based on the user entry, the validator operative to forward the processed entry for inclusion in the updated FAQ list based on the keywords indicating that the user question is not substantially similar to one already included in the existing FAQ list.

7. The apparatus of claim 1, the user entry comprising a user question that initiated a question thread on a forum and a plurality of user answers posted to the question thread, the data module operative to determine the accuracy rating as a plurality of answer-specific accuracy ratings, each of the plurality of answer-specific accuracy ratings corresponding to one of the plurality of user answers, the validator operative to select a best user answer from the plurality of user answers based on the plurality of answer-specific accuracy ratings and to indicate the selected best user answer in the forwarded processed entry, the list regenerator operative to use the user question and the selected best user answer as a new question-and-answer pair in the updated FAQ list.

8. The apparatus of claim 1, the user entry comprising a user question that initiated a question thread on a forum and a new user answer posted to the question thread, the existing FAQ list comprising a similar question to the user question, the data module operative to determine the accuracy rating based on the new user answer, the validator operative to forward the processed entry for inclusion based on the determined accuracy rating being higher than an existing accuracy rating for an associated answer to the similar question, the list regenerator operative to remove the associated answer as part of regenerating the existing FAQ list into the updated FAQ list.

9. The apparatus of claim 1, the validator operative to forward the processed entry for inclusion in the updated FAQ list based on a set of administrator-defined rules, the administrator-defined rules including one or more of:
a determined number of times a substantially similar question has been asked;
a predefined window of time within which the substantially similar questions were asked;
a list of recognized users with high accuracy ratings;
a threshold for a user helpfulness rating of a user answer, the user entry comprising the user answer; and
a predefined set of keywords wherein the rules may be set to include or not include question-answer pairs with those keywords in the updated FAQ list.

10. A computer-implemented method, comprising:
receiving a user entry to a forum;
generating a processed entry based on the user entry;
determining an accuracy rating of the processed entry;
regenerating an existing FAQ list into an updated FAQ list based on rules including the processed entry in response to the accuracy rating exceeding a threshold.

11. The method of claim 10, the user entry comprising a user question and a user answer, further comprising:
determining a number of times a substantially similar question to the user question has been asked, the processed entry included in the updated FAQ list based on the determined number of times exceeding a second threshold.

12. The method of claim 10, the user entry comprising a user question and a user answer, the processed entry comprising one or more keywords based on the user entry, comprising, the processed entry included in the updated FAQ list based on the keywords indicating that the user question is not substantially similar to one already included in the existing FAQ list.

13. The method of claim 10, the user entry comprising a user question that initiated a question thread on a forum and a plurality of user answers posted to the question thread, comprising:
determining the accuracy rating as a plurality of answer-specific accuracy ratings, each of the plurality of answer-specific accuracy ratings corresponding to one of the plurality of user answers;
selecting a best user answer from the plurality of user answers based on the plurality of answer-specific accuracy ratings; and
using the user question and the selected best user answer as a new question-and-answer pair in the updated FAQ list.

14. The method of claim 10, the user entry comprising a user question that initiated a question thread on a forum and a new user answer posted to the question thread, the existing FAQ list comprising a similar question to the user question, comprising:
determining the accuracy rating based on the new user answer;
including the processed entry in the updated FAQ list based on the determined accuracy rating being higher than an existing accuracy rating for an associated answer to the similar question; and
removing the associated answer as part of regenerating the existing FAQ list into the updated FAQ list.

15. The method of claim 10, the processed entry included in the updated FAQ list based on a set of administrator-defined rules, the administrator-defined rules including one or more of:
a determined number of times a substantially similar question has been asked;
a predefined window of time within which the substantially similar questions were asked;
a list of recognized users with high accuracy ratings;
a threshold for a user helpfulness rating of a user answer, the user entry comprising the user answer.

16. At least one computer-readable storage medium comprising instructions that, when executed, cause a system to:
receive a user entry to a forum;
generate a processed entry based on the user entry;
determine an accuracy rating of the processed entry;
regenerate an existing FAQ list into an updated FAQ list at real time, based on rules, including the processed entry in response to the accuracy rating exceeding a threshold.

17. The computer-readable storage medium of claim 16, the user entry comprising a user question and a user answer, the processed entry comprising one or more keywords based on the user entry, comprising, the processed entry included in the updated FAQ list based on the keywords indicating that the user question is not substantially similar to one already included in the existing FAQ list.

18. The computer-readable storage medium of claim 16, the user entry comprising a user question that initiated a question thread on a forum and a plurality of user answers posted to the question thread, comprising further instructions that, when executed, cause a system to:
determine the accuracy rating as a plurality of answer-specific accuracy ratings, each of the plurality of answer-specific accuracy ratings corresponding to one of the plurality of user answers;
select a best user answer from the plurality of user answers based on the plurality of answer-specific accuracy ratings; and
use the user question and the selected best user answer as a new question-and-answer pair in the updated FAQ list.

19. The computer-readable storage medium of claim 16, the user entry comprising a user question that initiated a question thread on a forum and a new user answer posted to the question thread, the existing FAQ list comprising a similar question to the user question, comprising further instructions that, when executed, cause a system to:
determine the accuracy rating based on the new user answer;
include the processed entry in the updated FAQ list based on the determined accuracy rating being higher than an existing accuracy rating for an associated answer to the similar question; and
remove the associated answer as part of regenerating the existing FAQ list into the updated FAQ list.

20. The computer-readable storage medium of claim 16, the processed entry included in the updated FAQ list based on a set of administrator-defined rules, the administrator-defined rules including one or more of:
a determined number of times a substantially similar question has been asked;
a predefined window of time within which the substantially similar questions were asked;
a list of recognized users with high accuracy ratings;
a threshold for a user helpfulness rating of a user answer, the user entry comprising the user answer.
